(19) United States
(12) Patent Application Publication
(10) Pub. No.: US 2026/0260408 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Makoto FUJINO, Osaka (JP)

(73) Assignee: PANASONIC INTELLECTUAL PROPERTY MANAGEMENT CO., LTD., Osaka (JP)

(21) Appl. No.: 19/659,303

(22) Filed: Apr. 27, 2026

Related U.S. Application Data
(63) Continuation of application No. PCT/JP2024/038795, filed on Oct. 31, 2024.
(60) Provisional application No. 63/546,972, filed on Nov. 2, 2023.

(30) Foreign Application Priority Data
Sep. 17, 2024 (JP) 2024-160194

(51) Int. Cl. G06T 11/60; G06F 3/04817; G06F 3/04845; G06T 7/11

(52) U.S. Cl. CPC G06T 11/60; G06F 3/04817; G06F 3/04845; G06T 7/11; G06T 2200/24; G06T 2207/20021

(57) ABSTRACT

An information processing method in a computer includes: displaying, on a display, a bird’s-eye view on which a plurality of imaging point icons are overlaid; partitioning the bird’s-eye view into a plurality of areas, each of the plurality of imaging point icons being associated with imaging data captured at imaging points corresponding to the plurality of imaging point icons, annotation information being added to the imaging data associated with at least one first imaging point icon included in the plurality of imaging point icons; and displaying, on the display, a first area including the at least one first imaging point icon in a display mode different from a display mode of a second area that does not include the at least one first imaging point icon.

### FIELD OF INVENTION

The present disclosure relates to a technique for changing a display mode of an image displayed on a display.

### BACKGROUND ART

The technique described in Patent Literature 1 discloses a display device including an image display means, a map display means, and a changing means. The image display means displays an image in an image display area of the display screen. The map display means displays a map in a map display area of the display screen. The changing unit changes the scale of the map such that the scale of the map displayed in the map display area increases as the number of captured images per unit area in the vicinity of the image capturing position of the image displayed in the image display area increases.

In the technique described in Patent Literature 1, it is not possible to clarify the location of an imaging point icon associated with image data to which annotation information is added. Therefore, in order to confirm the location of the imaging point icon associated with the image data to which annotation information is added, the processing steps of the computer increase, and the burden on the computer increases.

Patent Literature 1: JP 2009-237243 A

### SUMMARY OF THE INVENTION

The present disclosure has been made based on the above problem, and an object of the present disclosure is to provide a technique for suppressing an increase in a burden on a computer by clarifying the location of an imaging point icon in which the annotation information is added.

An information processing method according to one aspect of the present disclosure is an information processing method in a computer, the method including: displaying, on a display, a bird’s-eye view on which a plurality of imaging point icons are overlaid; partitioning the bird’s-eye view into a plurality of areas, each of the plurality of imaging point icons being associated with imaging data captured at imaging points corresponding to the plurality of imaging point icons, annotation information being added to the imaging data associated with at least one first imaging point icon included in the plurality of imaging point icons; and displaying, on the display, a first area including the at least one first imaging point icon in a display mode different from a display mode of a second area that does not include the at least one first imaging point icon.

According to the present disclosure, it is possible to clarify the location of the imaging point icon in which the annotation information is added. Therefore, an increase in load on the computer can be suppressed.

### BRIEF DESCRIPTION OF THE DRAWINGS

FIG. 1 is a block diagram illustrating one example of an entire configuration of an information processing system in the present embodiment.

FIG. 2 is a block diagram illustrating another example of an overall configuration of the information processing system.

FIG. 3 is a flowchart illustrating an example of a flow of processing performed in the information processing system.

FIG. 4 is a view illustrating an example of a display screen displayed on a display of an information terminal.

FIG. 5 is a view illustrating an example of a display screen displayed on the display by the information terminal that has received an operation of reducing and displaying a design drawing.

FIG. 6 is a view illustrating a display screen displayed on the display when the information terminal receives an operation for designating enlargement of an area V illustrated in FIG. 2.

FIG. 7 is a view illustrating an example of a status icon.

FIG. 8 is a view illustrating an example of a display screen displayed on the display in Modification (3).

FIG. 9 is a view illustrating an example of a display screen displayed on the display in Modification (8).

### DETAILED DESCRIPTION

(Knowledge underlying present disclosure) There has been developed a user interface that displays a plurality of imaging point icons indicating imaging points at which a construction site or the like is actually captured on a two-dimensional design drawing of a site such as a construction site, and displays an image captured at an imaging point indicated by one imaging point icon when the one imaging point icon is selected. Thus, the administrator of the construction site can know the situation of the construction site without visiting the construction site.

In the user interface described above, annotation information may be added to imaging data associated with at least one imaging point icon among a plurality of imaging point icons. Here, in a case where a plurality of imaging point icons are displayed on the design drawing, it is not easy for the user to grasp which imaging point icon has imaging data to which the annotation information is added to. In this case, the user may input, to the computer, an operation for searching for the imaging point icon in which the annotation information is added to the imaging data. This increases the processing steps of the computer, and consequently increases the burden on the computer.

It is difficult to solve such a problem with the technology described in Patent Literature 1. Patent Literature 1 merely discloses a technique for increasing the scale of a map based on the number of captured images per unit area, and does not disclose a technique for clarifying the location of an imaging point icon in which the annotation information is added to imaging data.

In order to solve the above problems, the following technique is disclosed.

(1) An information processing method according to one aspect of the present disclosure is an information processing method in a computer, the method including: displaying, on a display, a bird’s-eye view on which a plurality of imaging point icons are overlaid; partitioning the bird’s-eye view into a plurality of areas, each of the plurality of imaging point icons being associated with imaging data captured at imaging points corresponding to the plurality of imaging point icons, annotation information being added to the imaging data associated with at least one first imaging point icon included in the plurality of imaging point icons; and displaying, on the display, a first area including the at least one first imaging point icon in a display mode different from a display mode of a second area that does not include the at least one first imaging point icon.

With this configuration, the first area including the first imaging point icon can be displayed on the display in a mode different from the second area not including the first imaging point icon. That is, it is possible to make the first area including the first imaging point icon that is the imaging point icon in which the annotation information is added to the imaging data stand out. Thus, it is possible to clarify the location of the imaging point icon in which the annotation information is added to the imaging data. In this manner, it is not necessary to input an operation for searching for the imaging point icon in which the annotation information is added to the imaging data to the computer, and thus it is possible to suppress an increase in the processing steps of the computer. As a result, it is possible to suppress an increase in the load on the computer.

(2) The information processing method according to (1) may further include detecting enlargement or reduction of the bird’s-eye view, in which the displaying the first area on the display in a mode different from the second area may be performed in response to detection of enlargement or reduction of the bird’s-eye view.

With this configuration, the display mode of the first area can be made different from that of the second area by using the enlargement or reduction of the bird’s-eye view as a trigger.

(3) In the information processing method according to (1) or (2), the displaying the first area on the display in a mode different from the second area may include changing a display mode of the first area based on a number of the first imaging point icons included in the first area.

With this configuration, the display mode of the first area changes based on the number of first imaging point icons. In this manner, for example, there is a difference in the display mode of the first area between a case where the first area includes a large number of first imaging point icons and a case where the first area includes a small number of first imaging point icons. Therefore, the user can understand the number of first imaging point icons included in the first area.

(4) In the information processing method according to any one of (1) to (3), the displaying the first area on the display in a mode different from the second area may include displaying a total number of the first imaging point icons in the first area.

With this configuration, the user can clearly understand the total number of first imaging point icons included in the first area.

(5) In the information processing method according to any one of (1) to (4), the annotation information may include label information indicating a status of a subject related to the imaging data, and the displaying the first area on the display in a mode different from the second area may include displaying the first area in a different mode for each type of the label information added to the imaging data of the first imaging point icon.

With this configuration, since the display mode of the first area changes according to the type of label information added to the imaging data of the first imaging point icon, it is easy for the user to understand the type of label information added to the imaging data of the first imaging point icon.

(6) In the information processing method according to any one of (1) to (5), the annotation information may include comment information indicating a comment added to the imaging data, the information processing method may further include detecting an input of a keyword, and the displaying the first area on the display in a mode different from the second area may include: specifying, in the first area, an area with a keyword including the first imaging point icon in which comment information including the keyword is added to the imaging data; and making a display mode of the area with a keyword different from a display mode of the second area.

With this configuration, it is possible to clarify the location of the first imaging point icon in which the comment information including the keyword is added to the imaging data.

(7) In the information processing method according to any one of (1) to (6), the displaying the first area on the display in a mode different from the second area may include making a display mode of the first imaging point icon different from a display mode of at least one second imaging point icon included in the plurality of imaging point icons, the second imaging point icon having no annotation information added to the imaging data.

With this configuration, the display modes of the first imaging point icon in which the annotation information is added to the imaging data and the second imaging point icon in which the annotation information is not added to the imaging data can be made different from each other. Thus, it is possible to clarify to which of the plurality of imaging point icons displayed on the display the annotation information is added.

(8) The information processing method according to (7) may further include: detecting enlargement or reduction of the bird’s-eye view; and determining whether or not a degree of overlap between the first imaging point icon and the second imaging point icon is equal to or greater than a reference degree of overlap in response to detection of enlargement or reduction of the bird’s-eye view, in which the displaying the first area on the display in a mode different from the second area may include making a display mode of the first imaging point icon different from a display mode of the second imaging point icon when the degree of overlap between the first imaging point icon and the second imaging point icon is equal to or greater than the reference degree of overlap.

When the degree of overlap between the first imaging point icon and the second imaging point icon is equal to or greater than the reference degree of overlap, the visibility of the first imaging point icon may decrease.

On the other hand, according to the above configuration, when the degree of overlap is equal to or greater than the reference degree of overlap, the first imaging point icon is displayed on the display in a mode different from the second imaging point icon, so that the location of the first imaging point icon can be made clearer.

(9) In the information processing method according to any one of (1) to (8), the partitioning the bird’s-eye view into the plurality of areas may include setting a grid-like boundary line in the bird’s-eye view.

With this configuration, since the bird’s-eye view is divided into a plurality of areas by the grid-like boundary lines, the shape of each area can be set to a simple shape. Thus, the visibility of the bird’s-eye view is improved as compared with a case where the shape of each area is set to a complicated shape. As a result, the location of the first imaging point icon is further clarified.

(10) In the information processing method according to any one of (1) to (9), the bird’s-eye view may include floor plan information indicating a shape of each of a plurality of spaces included in a building, the information processing method may further include detecting enlargement or reduction of the bird’s-eye view, and the partitioning the bird’s-eye view into the plurality of areas may include setting a boundary line of a shape along the shape of each of the plurality of spaces in the bird’s-eye view based on the floor plan information in response to detection of enlargement or reduction of the bird’s-eye view.

With this configuration, the boundary line of the shape along each shape of the plurality of spaces included in the building is set in the bird’s-eye view based on the floor plan information. Thus, a plurality of spaces included in the building and a plurality of areas on the design drawing correspond to each other. By displaying the first area in a mode different from the second area in this state, it is possible to clarify in which space in the building the first imaging point icon is disposed.

(11) In the information processing method according to any one of (1) to (10), the bird’s-eye view may be associated with function information indicating a function of each of a plurality of spaces of a building, the information processing method may further include detecting enlargement or reduction of the bird’s-eye view, and the partitioning the bird’s-eye view into the plurality of areas may include setting a boundary line in the bird’s-eye view such that the bird’s-eye view is partitioned for each function of the plurality of spaces in response to detection of enlargement or reduction of the bird’s-eye view.

With this configuration, since the design drawing is divided into a plurality of areas for each function of a plurality of spaces included in the building, the function of the area where the first imaging point icon is disposed can be clarified.

(12) In the information processing method according to any one of (1) to (11), the bird’s-eye view may include a first floor map corresponding to a first floor included in a building and a second floor map corresponding to a second floor different from the first floor included in the building, and the displaying the first area on the display in a mode different from the second area may include displaying a floor map including the first imaging point icon out of the first floor map and the second floor map on the display in a mode different from a floor map not including the first imaging point icon.

With this configuration, it is possible to clarify which floor of the building the first imaging point icon is disposed on.

(13) The information processing method according to any one of (1) to (12) may further include: detecting enlargement of the bird’s-eye view; determining whether or not an enlargement ratio is equal to or larger than a reference enlargement ratio when the enlargement of the bird’s-eye view is detected; specifying a position of a first range displayed on the display in the bird’s-eye view and positions and a number of the first imaging point icons included in a second range not displayed on the display in the bird’s-eye view when the enlargement ratio is equal to or larger than the reference enlargement ratio; and displaying guidance information indicating positions and the number of the first imaging point icons included in the second range on the display together with the first range.

With this configuration, when the first range of the design drawing is displayed on the display, the guidance information indicating the positions and the number of the first imaging point icons present outside the display screen of the display (the second range of the design drawing) can be presented to the user. In this manner, the user can easily grasp the positions and the number of the first icons present outside the display screen of the display.

Further, the present disclosure can be implemented not only as an information processing method for executing the characteristic processing as described above, but also as an information processing device or the like having a characteristic configuration corresponding to characteristic processing executed with the information processing method. Further, the present disclosure can also be realized as a computer program that causes a computer to execute characteristic processing included in the information processing method described above. Therefore, an effect similar to the effect in the above information processing method can also be achieved by another aspect described below.

(14) An information processing device according to another aspect of the present disclosure is an information processing device including a processor, in which the processor is configured to execute: displaying, on a display, a bird’s-eye view on which a plurality of imaging point icons are overlaid; partitioning the bird’s-eye view into a plurality of areas, each of the plurality of imaging point icons being associated with imaging data captured at imaging points corresponding to the plurality of imaging point icons, annotation information being added to the imaging data associated with at least one first imaging point icon included in the plurality of imaging point icons; and displaying, on the display, a first area including the at least one first imaging point icon in a display mode different from a display mode of a second area that does not include the at least one first imaging point icon.

(15) An information processing program according to still another aspect of the present disclosure causes a computer to execute: displaying, on a display, a bird’s-eye view on which a plurality of imaging point icons are overlaid; partitioning the bird’s-eye view into a plurality of areas, each of the plurality of imaging point icons being associated with imaging data captured at imaging points corresponding to the plurality of imaging point icons, annotation information being added to the imaging data associated with at least one first imaging point icon included in the plurality of imaging point icons; and displaying, on the display, a first area including the at least one first imaging point icon in a display mode different from a display mode of a second area that does not include the at least one first imaging point icon.

The present disclosure can be also implemented as an information processing system that is operated by such an information processing program. Further, it is needless to say that the present disclosure allows such a program to be distributed using a computer-readable non-transitory recording medium such as a CD-ROM, or via a communication network such as the Internet.

Hereinafter, an embodiment of the present disclosure will be described with reference to the drawings. Note that each embodiment to be described below illustrates a specific example of the present disclosure. Numerical values, shapes, components, steps, order of steps, and the like of the embodiments below are merely examples, and are not intended to limit the present disclosure. Further, a component not described in an independent claim representing a highest concept among components in the embodiments below is described as an optional component. In all the embodiments, respective contents can be combined.

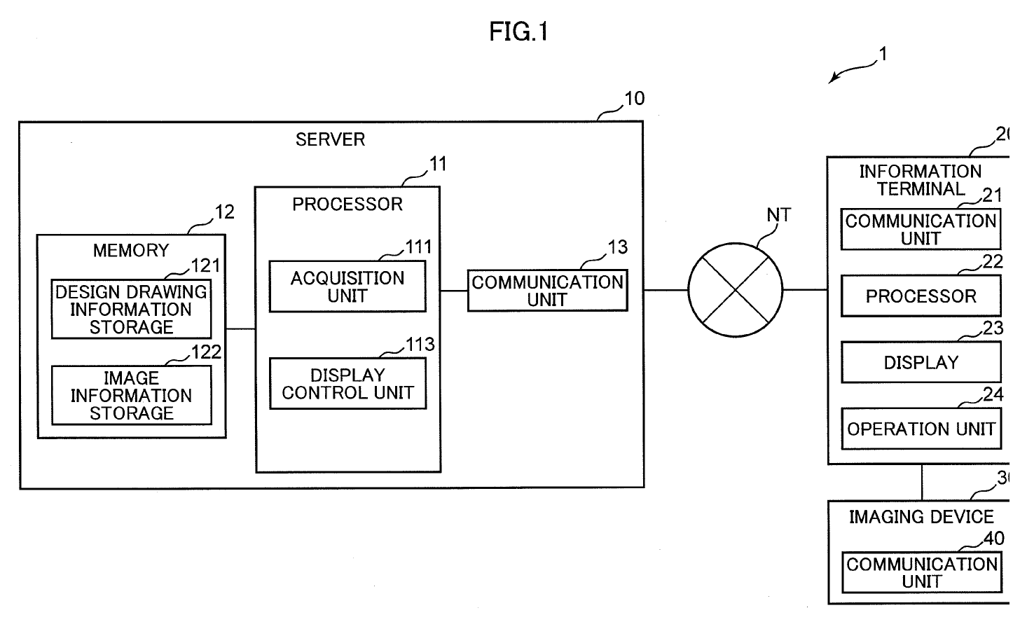

(First embodiment) FIG. 1 is a block diagram illustrating one example of an entire configuration of an information processing system 1 in the present embodiment. The information processing system 1 includes a server 10, an information terminal 20, and an imaging device 30.

The server 10 is an example of an information processing device and a computer. The server 10, the information terminal 20, and the imaging device 30 are communicably connected to each other via a network NT. An example of the network NT is the Internet. The server 10 is, for example, a cloud server including one or more computers. However, this is an example, and the server 10 may be configured as an edge server or may be implemented in the information terminal 20. An aspect in which the server 10 is implemented in the information terminal 20 is an example of an aspect in which the information terminal 20 is configured as an information processing device.

The information terminal 20 is a terminal operated by a user. The user is, for example, an administrator of a predetermined space imaged by the imaging device 30. The predetermined space is, for example, a construction site of a building. However, this is an example, and the predetermined space may be a building site, a factory, a store, an office, or the like. The information terminal 20 may be configured as, for example, a portable computer such as a smartphone or a tablet computer or may be configured as a stationary computer. Although one information terminal 20 is illustrated in the example of FIG. 1, a plurality of information terminals may be connected to the server 10 via the network NT. The information terminal 20 includes a communication unit 21, a processor 22, a display 23, and an operation unit 24.

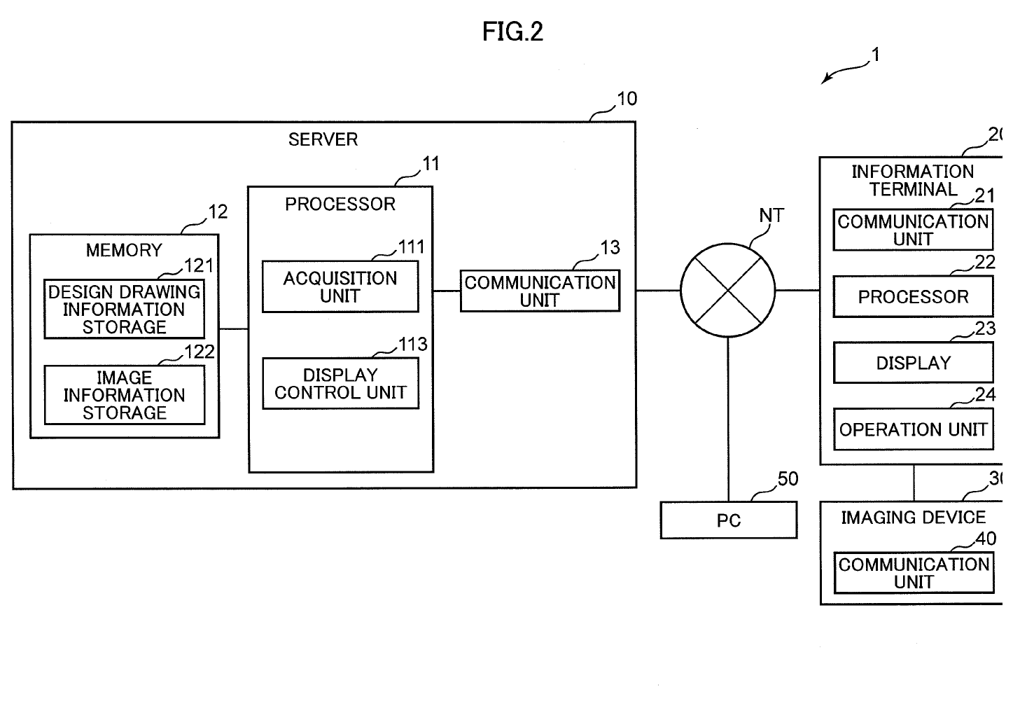

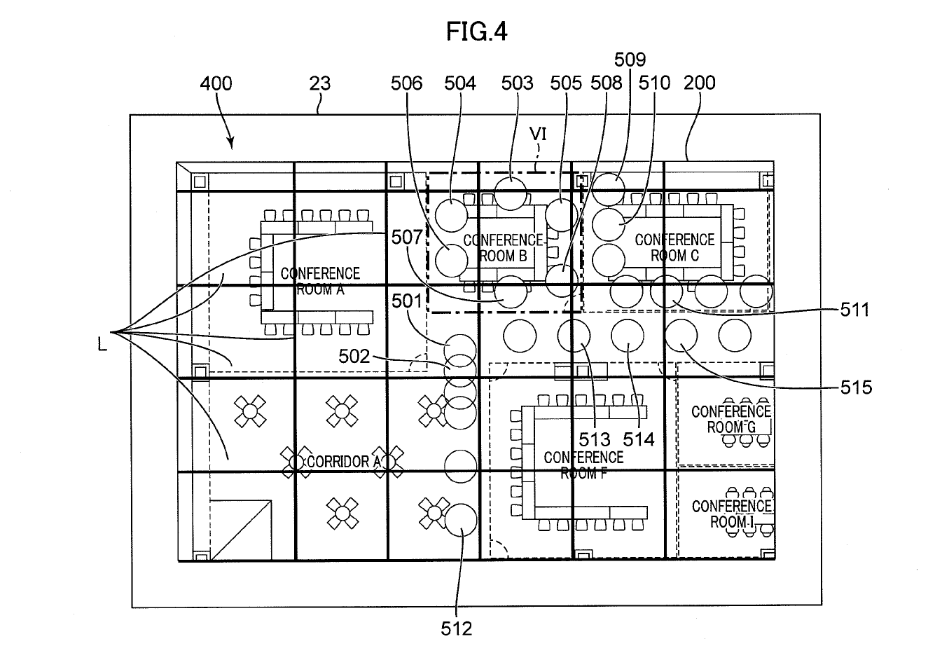

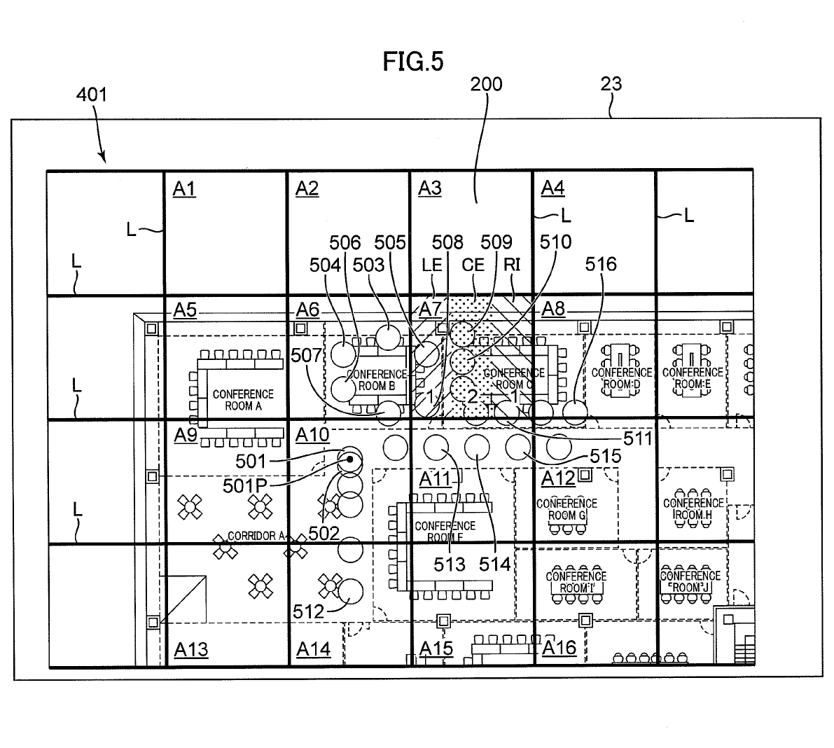

FIG. 2 is a block diagram illustrating another example of the overall configuration of the information processing system 1. As illustrated in FIG. 2, the information processing system 1 may include a PC 50 connected to a network NT. The PC 50 is an information processing terminal installed in a place other than the site, for example, an office located away from the site. The PC 50 can be configured as various information processing terminals such as a stationary personal computer, a laptop personal computer, a smartphone, and a tablet computer. A design drawing 200 (FIGS. 4 and 5) to be described later may be displayed on a display (not illustrated) provided or connected to the PC 50.

The communication unit 21 is a communication interface that connects the information terminal 20 to the network NT. The communication unit 21 transmits signals indicating various instructions received from the user by the operation unit 24 to the server 10.

The processor 22 includes, for example, a central processing unit (CPU), and causes the display 23 to display the design drawing of the predetermined space transmitted from the server 10. The design drawing is an example of a bird’s-eye view. The design drawing is a drawing illustrating a design of a construction site. Specifically, the design drawing is a bird’s-eye view of a building including a pillar, a wall, or a material. The bird’s-eye view may be an overhead view, and may be a view from above. The design drawing may be a plan view, a blueprint, a map, a perspective view, or the like of the construction site.

The display 23 is configured as various display devices such as a liquid crystal display and an organic EL display, and displays various display screens under the control of the processor 22.

The operation unit 24 includes, for example, a keyboard, a touch panel, a mouse, and the like. The user inputs various instructions to the information terminal 20 by operating the operation unit 24.

The imaging device 30 is configured as, for example, an omnidirectional camera, and captures imaging data (image) at a predetermined frame rate. The omnidirectional camera is also referred to as a 360 degree camera, and is a camera capable of acquiring an omnidirectional imaging data of 360 degrees. The imaging device 30 is, for example, a portable imaging device carried by an operator. The operator is, for example, a worker or a site supervisor at a construction site. Note that the imaging device 30 may be configured as a normal camera. The imaging device 30 includes an image sensor, an operation device, a communication circuit, a signal processing circuit, and the like. The imaging device 30 may be configured as a portable computer such as a smartphone or a tablet computer. The imaging device 30 includes a communication unit 40. The communication unit 40 communicably connects the information terminal 20 and the imaging device 30 to each other via a close proximity wireless communication path such as Bluetooth (registered trademark) or a wireless LAN.

The operator downloads a design drawing of the site from the server 10 to the information terminal 20, causes the information terminal 20 to display the design drawing, and connects the information terminal 20 and the imaging device 30 using a wireless LAN or the like. Thus, an imaging start button is displayed on the information terminal 20, and therefore the operator presses the imaging start button in a state where the imaging device 30 is directed in a predetermined direction, and starts imaging. The predetermined direction is a direction for matching the direction with the design drawing displayed on the display 23. The predetermined direction is, for example, the north direction, but is not limited thereto. The operator moves on site while performing imaging by the imaging device 30. Thus, a plurality of pieces of imaging data (image data) are generated. Upon reaching an imaging end point, the operator presses an imaging end button displayed on the information terminal 20. At this time, the operator touches the design drawing displayed on the information terminal 20, and instructs the imaging end point on the design drawing. Note that, when the imaging by the imaging device 30 is started, the operator may designate an imaging start point by touching the design drawing displayed on the information terminal 20. When the operator instructs the imaging end point, transfer of the plurality of pieces of imaging data from the imaging device 30 to the information terminal 20 is started. The plurality of transferred imaging data are temporarily accumulated in the information terminal 20. The plurality of pieces of imaging data accumulated in the information terminal 20 are uploaded to the server 10 when the operator operates the information terminal 20.

Upon acquiring the plurality of pieces of imaging data from the information terminal 20, the server 10 analyzes position information on the design drawing of each piece of imaging data by using a visual simultaneous localization and mapping (SLAM) technology based on the imaging start point, the imaging end point, and the plurality of pieces of imaging data, and adds (links) the position information on the design drawing to each piece of imaging data. In the design drawing, two-dimensional coordinate axes are defined. Therefore, the position information on the design drawing of each piece of imaging data is defined by two-dimensional coordinate values. The server 10 overlays an imaging point icon indicating an imaging point of each piece of imaging data on the design drawing based on the position information on the design drawing of each piece of imaging data. Thus, a design drawing in which a plurality of imaging point icons are overlaid is generated. The series of processing is executed by, for example, an acquisition unit 111 described later of the server 10.

A worker at the site causes the information terminal 20 to display the design drawing generated by the server 10 at an appropriate timing. That is, the information terminal 20 is caused to display the design drawing on which the plurality of imaging point icons are overlaid. Then, by designating (for example, touching) a specific imaging point icon among the plurality of imaging point icons, the imaging data can be called and displayed. In addition, annotation information can be added to the imaging data.

The annotation information is a kind of meta information added to the imaging data. The annotation information according to the present embodiment includes comment information and label information. One or both of the comment information and the label information is added to the imaging data.

The comment information is a text (character string) added to predetermined imaging data by a worker who performs predetermined work on site. For example, the worker attaches a text “Starting work on April 1. Worker X, Company A” to the predetermined imaging data. This text is the comment information. The comment information added to the imaging data by the worker is stored in an image information storage 122 of a memory 12 in a state of being associated with the imaging data. Not only the worker but also a person such as a site supervisor of a construction site may add the comment information to the imaging data.

The label information indicates a status of a construction site (an example of a subject) related to the imaging data. The label information according to the present embodiment includes three types of class labels of “not started”, “in progress”, and “resolved”. The worker adds an appropriate class label to the imaging data according to the status of the construction site included in the imaging data.

Specifically, the worker adds a class label according to a degree of progress of a predetermined work performed at the construction site reflected in the imaging data. For example, the worker adds a class label of “not started” to the imaging data in which the construction site where the worker has not started working is captured. Further, the worker adds a class label of “in progress” to the imaging data in which the construction site where the work is in progress is captured. Further, the worker adds a class label of “resolved” to the imaging data in which the construction site where the work is completed is captured. The class label may be added by a site supervisor or the like.

The above class labels are merely examples, and the worker may add a wide variety of class labels according to the status of the subject. That is, the class label added to the imaging data by the worker is not limited to “not started”, “in progress”, or “resolved”.

Various pieces of meta information are added to the imaging data captured by the imaging device 30 in addition to the annotation information. For example, meta information such as imaging date and time information and a design drawing ID is added to each piece of imaging data. The imaging date and time information indicates a year, month, day, time, and the like when imaging has been performed. The design drawing ID is identification information used when specifying a design drawing corresponding to a construction site where imaging has been performed. The information terminal 20 or the imaging device 30 generates the meta information such as the imaging date and time information and the design drawing ID, and gives the meta information to each piece of imaging data. Note that, in a case where the imaging device 30 or the information terminal 20 includes a position sensor such as a GPS sensor, information indicating the latitude and longitude of the imaging point may be added to each piece of imaging data.

The server 10 includes a processor 11, the memory 12, and a communication unit 13.

The processor 11 includes, for example, a central processing unit (CPU), a graphics processing unit (GPU), or the like. The processor 11 includes an acquisition unit 111 and a display control unit 113. The acquisition unit 111 and the display control unit 113 may be implemented by the processor 11 executing the information processing program, or may be constituted by a dedicated hardware circuit such as an ASIC.

The acquisition unit 111 acquires the imaging data transmitted from the imaging device 30 and the meta information added to the imaging data. Further, the acquisition unit 111 executes VSLAM processing described above to generate a design drawing on which a plurality of imaging point icons are overlaid.

The acquisition unit 111 acquires a display instruction from the information terminal 20 by communicating with the information terminal 20 or the PC 50 using the communication unit 13. The display instruction is an instruction input by the user to the information terminal 20 or the PC 50. The display instruction is an instruction for requesting display of a design drawing on which a plurality of imaging point icons are overlaid on the display 23 of the information terminal 20 or the display of the PC 50. The display instruction includes a design drawing ID that is an identifier of a design drawing that the user requests to display on the display 23. Hereinafter, it is assumed that an instruction for requesting display of a design drawing on which a plurality of imaging point icons are overlaid on the display 23 of the information terminal 20 is input as a display instruction.

The display control unit 113 generates various instructions for controlling the information terminal 20 and transmits the instructions to the information terminal 20. The information terminal 20 that has received the instruction generated by the display control unit 113 displays, on the display 23, a design drawing on which a plurality of imaging point icons are overlaid. Further, the information terminal 20 that has received the instruction partitions the design drawing into a plurality of areas. For example, the information terminal 20 sets at least one boundary line for partitioning the design drawing into a plurality of areas on the design drawing. Further, the information terminal 20 that has received the instruction displays, on the display 23, a first area including a first imaging point icon to be described later among the plurality of areas in a mode different from a second area not including the first imaging point icon among the plurality of areas.

The memory 12 is constituted by a nonvolatile rewritable storage device such as a hard disk drive or a solid state drive. The memory 12 includes a design drawing information storage 121 and an image information storage 122.

The design drawing information storage 121 stores at least one of the design drawings. Further, the design drawing information storage 121 stores a design drawing ID added to each of the at least one design drawing and the position information of each of the at least one design drawings. The position information of the design drawing is information indicating a geographical position of a predetermined space corresponding to the design drawing. For example, when the design drawing corresponds to a building site, information indicating the latitude and longitude of the building site is stored in the design drawing information storage 121. Specifically, latitudes and longitudes corresponding to key points (for example, four corners of the design drawing) of the design drawing are stored.

The image information storage 122 stores a plurality of pieces of imaging data transmitted from the information terminal 20 to the server 10 and meta information added to each of the plurality of pieces of imaging data.

The meta information stored in the image information storage 122 may include information such as an imaging ID, an imaging period ID, an imaging direction, and position information of an imaging point icon.

The imaging ID is an identifier added to each piece of imaging data. The imaging period ID is an identifier of the imaging period. The imaging period refers to a period from the start to the end of the imaging operation. The imaging direction indicates a direction in which the imaging device 30 is directed when each piece of imaging data is captured. The position information of the imaging point icon indicates a display position of the imaging point icon on the design drawing. The position information of the imaging point icon is represented by, for example, coordinate values in a two-dimensional coordinate system defined in the design drawing.

The communication unit 13 is a communication interface that connects the server 10 to the network.

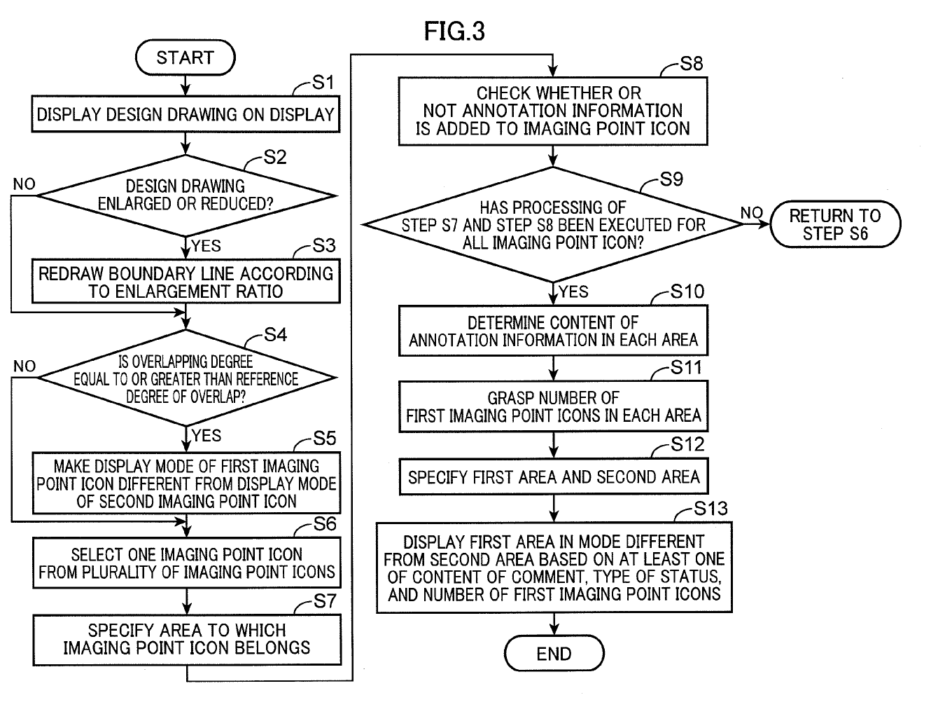

FIG. 3 is a flowchart illustrating an example of a flow of processing performed in the information processing system 1.

In step S1, the information terminal 20 displays the design drawing on the display 23. Specifically, in step S1, the user operates the operation unit 24 to input a display instruction to the information terminal 20. The information terminal 20 that has received the display instruction transmits the display instruction to the server 10. The acquisition unit 111 of the server 10 that has received the display instruction reads the design drawing indicated by the design drawing ID included in the display instruction from the design drawing information storage 121 of the memory 12. At this time, using the design drawing ID as a key, the acquisition unit 111 reads, from the image information storage 122 of the memory 12, various types of information such as imaging data having an imaging ID associated with the design drawing ID, position information indicating a display position on the design drawing of an imaging point icon indicating an imaging point of the imaging data, and annotation information added to the imaging data. The acquisition unit 111 inputs the information read from the memory 12 to the display control unit 113. The display control unit 113 generates an instruction based on the information acquired from the acquisition unit 111. Specifically, an instruction to display the design drawing read by the acquisition unit 111 on the display 23 and to overlay boundary lines for dividing the design drawing into a plurality of areas on the design drawing is generated and transmitted.

FIG. 4 is a view illustrating an example of a display screen 400 displayed on the display 23 by the information terminal 20 according to the instruction received from the display control unit 113. As illustrated in FIG. 4, the display screen 400 includes a design drawing 200 on which a plurality of imaging point icons are overlaid. In the example illustrated in FIG. 4, the plurality of imaging point icons includes imaging point icons 501 to 515. Note that, for convenience of description, in FIG. 4, the imaging point icons other than the imaging point icons 501 to 515 are not denoted by reference numerals. Here, each of the plurality of imaging point icons is configured as a circular image. Each of the plurality of imaging point icons is associated with at least one imaging data captured at the imaging point indicated by each of the plurality of imaging point icons. Hereinafter, it is assumed that one imaging data is associated with one imaging point icon unless otherwise specified.

The annotation information is added to the imaging data of at least one imaging point icon among the plurality of imaging point icons. Hereinafter, the imaging point icon in which the annotation information is added to the imaging data is referred to as a first imaging point icon. Further, in the following description, among the plurality of imaging point icons, the imaging point icon to which the annotation information is not added to the imaging data is referred to as a second imaging point icon. That is, the plurality of imaging point icons include at least one first imaging point icon in which the annotation information is added to the imaging data and at least one second imaging point icon in which the annotation information is not added to the imaging data.

Further, as illustrated in FIG. 4, the display screen 400 includes grid-like boundary lines L (grid lines). That is, boundary lines L including a plurality of vertical lines and a plurality of horizontal lines orthogonal to each other are drawn on the display screen 400. The design drawing 200 is divided into a plurality of areas by the boundary lines L. In the example illustrated in FIG. 4, the plurality of areas are formed in a square shape. However, this is merely an example, and the plurality of areas may be formed in a rectangular shape.

In step S2, the display control unit 113 determines whether or not enlargement or reduction of the design drawing has been detected. Specifically, the display control unit 113 communicates with the information terminal 20. Then, the display control unit 113 determines whether or not the information terminal 20 has received, from the user, an operation (hereinafter referred to as an enlargement/reduction operation) for requesting display of the enlarged or reduced design drawing on the display 23. When the information terminal 20 has received the enlargement/reduction operation, the display control unit 113 determines that the enlargement or reduction has been detected (YES in step S2). In this case, the processing proceeds to step S3. On the other hand, when the information terminal 20 has not received the enlargement/reduction operation, the display control unit 113 determines that the enlargement or reduction has not been detected (NO in step S2). In this case, the processing proceeds to step S4.

In step S3, the information terminal 20 redraws the boundary lines L according to an enlargement ratio of the design drawing. For example, in step S2, it is assumed that the information terminal 20 has received an operation of reducing the design drawing 200 (an operation of reducing the enlargement ratio of the design drawing). Further, it is assumed that, with the enlargement ratio of the design drawing 200 illustrated in FIG. 4 being 100%, the enlargement/reduction operation includes an operation for requesting setting of the enlargement ratio of the design drawing 200 to 80%. In this case, the information terminal 20 displays, on the display screen 400, the design drawing 200 having the enlargement ratio set to 80%. Further, at this time, the information terminal 20 redraws the boundary lines L according to the enlargement ratio (enlargement ratio 80%) designated by the user. Specifically, the arrangement interval of the plurality of vertical lines and the arrangement interval of the plurality of horizontal lines included in the boundary lines L, the number of vertical lines or horizontal lines, and the like are adjusted in response to the reduction of the design drawing 200.

FIG. 5 is a view illustrating an example of the display screen 401 displayed on the display 23 by the information terminal 20 that has received the operation of reducing and displaying the design drawing 200. The display screen 401 illustrated in FIG. 5 includes a reduced design drawing 200 as compared to the design drawing 200 illustrated in FIG. 4. Further, the display screen 401 includes the boundary lines L redrawn in the processing of step S3. The design drawing 200 is partitioned into a plurality of areas from an area A1 to an area A16 by the boundary lines L.

Meanwhile, some (for example, two) imaging point icons among the plurality of imaging point icons may be displayed on the display 23 in a state of overlapping each other. For example, in a case where the design drawing 200 is reduced while maintaining the display size of each of the plurality of imaging point icons on the display screen, the imaging point icons are densely arranged, whereby the two imaging point icons may be displayed on the display 23 in a state of overlapping each other. Specifically, in FIG. 5, the imaging point icon 501 and the imaging point icon 502 are displayed on the display screen 401 in a state of overlapping each other. It is assumed that the imaging point icon 501 is a first imaging point icon, and the imaging point icon 502 is a second imaging point icon. Here, when the degree of overlap between the first imaging point icon and the second imaging point icon is equal to or greater than the reference degree of overlap, the first imaging point icon is hidden by the second imaging point icon, and the visibility of the first imaging point icon is reduced. The degree of overlap indicates a ratio of the area of the second imaging point icon to the area of the first imaging point icon.

Therefore, in step S4, the display control unit 113 according to the present embodiment determines whether or not the degree of overlap between the first imaging point icon and the second imaging point icon is equal to or greater than a reference degree of overlap. Then, when the degree of overlap is equal to or greater than the reference degree of overlap (YES in step S4), the display control unit 113 transmits, to the information terminal 20, an instruction to make the display mode of the first imaging point icon different from the display mode of the second imaging point icon in step S5.

Specifically, in step S4, the display control unit 113 specifies the first imaging point icon from among the plurality of imaging point icons displayed on the display 23. Subsequently, the display control unit 113 specifies the second imaging point icon overlaid on the first imaging point icon. Then, the display control unit 113 determines whether or not the degree of overlap between the first imaging point icon and the second imaging point icon is equal to or greater than the reference degree of overlap. The reference degree of overlap is not particularly limited, but is, for example, 50%. When the degree of overlap between the first imaging point icon and the second imaging point icon is equal to or greater than the reference degree of overlap (YES in step S4), the processing proceeds to step S5. On the other hand, when the degree of overlap between the first imaging point icon and the second imaging point icon is less than the reference degree of overlap (NO in step S4), the processing proceeds to step S6.

When there is no second imaging point icon overlaid on the first imaging point icon in step S4, the display control unit 113 determines NO in step S4.

In addition, in step S4, the display control unit 113 may determine whether or not a plurality of second imaging point icons are overlaid on one first imaging point icon. Then, in a case where the plurality of second imaging point icons are overlaid on one first imaging point icon, it may be determined whether or not the ratio of the total area of the plurality of second imaging point icons to the area of the first imaging point icon is equal to or greater than the reference degree of overlap. Then, when the ratio of the total area of the plurality of second imaging point icons to the area of the first imaging point icon is equal to or greater than the reference degree of overlap, YES may be determined in step S4.

In step S5, the display control unit 113 transmits, to the information terminal 20, an instruction to make the display mode of the first imaging point icon different from the display mode of the second imaging point icon. The instruction to make the display mode of the first imaging point icon different from the display mode of the second imaging point icon is, for example, an instruction to hide the second imaging point icon. It is assumed that the imaging point icon 502illustrated in FIG. 5 is the second imaging point icon, the imaging point icon 501 is the first imaging point icon, and the imaging point icon 502 overlaps the imaging point icon 501 by the reference degree of overlap or more. In this case, the display control unit 113 transmits an instruction to hide the imaging point icon 502 to the information terminal 20.

In addition, in step S5, the display control unit 113 may transmit, to the information terminal 20, an instruction to arrange the first imaging point icon on the forefront in order to make the display mode of the first imaging point icon different from the display mode of the second imaging point icon. For example, it is assumed that the display screen 401 illustrated in FIG. 5 includes a first layer on which the design drawing 200 is drawn, a second layer on which the imaging point icon 501 (first imaging point icon) is drawn, and a third layer on which the imaging point icon 502 (second imaging point icon) is drawn. In this case, the display control unit 113 transmits an instruction to arrange the second layer on the forefront to the information terminal 20. In this manner, the imaging point icon 501 is preferentially displayed on the display screen 401 over the imaging point icon 502.

In addition, in step S5, the display control unit 113 may transmit, to the information terminal 20, an instruction to make the radius of the first imaging point icon larger than the radius of the second imaging point icon. In addition, the display control unit 113 may transmit, to the information terminal 20, an instruction to change the image constituting the first imaging point icon to a quadrangular image. In addition, the display control unit 113 may transmit, to the information terminal 20, an instruction to add a border line to the peripheral edge portion of the circular image constituting the first imaging point icon.

In addition, in step S5, the display control unit 113 may transmit, to the information terminal 20, an instruction to make the radius of the second imaging point icon overlaid on the first imaging point icon smaller than the radius of the first imaging point icon. In addition, the display control unit 113 may transmit, to the information terminal 20, an instruction to change the transmittance of the second imaging point icon overlaid on the first imaging point icon to make the second imaging point icon transparent. In this manner, the display control unit 113 improves the visibility of the first imaging point icon.

In step S6, the display control unit 113 selects one imaging point icon from the plurality of imaging point icons.

In step S7, the display control unit 113 specifies an area to which the imaging point icon selected in step S6 belongs. The display control unit 113 determines an area to which the imaging point icon belongs based on the position (coordinates) of the center point of the imaging point icon. For example, it is assumed that the imaging point icon 501 illustrated in FIG. 5 is selected by the display control unit 113 in step S6. As illustrated in FIG. 5, a center point 501P of the imaging point icon 501 is present inside the area A10. In this case, the display control unit 113 specifies that the imaging point icon 501 belongs to the area A10.

In step S8, the display control unit 113 checks whether or not annotation information is added to the imaging data of the imaging point icon selected in step S6. That is, it is confirmed whether or not an arbitrary imaging point icon is the first imaging point icon.

In step S9, the display control unit 113 determines whether or not the processing of steps S7 and S8 has been executed for all the imaging point icons overlaid and displayed on the design drawing 200. When the processing related to steps S7 and S8 has been executed for all the imaging point icons (YES in step S9), the processing proceeds to step S10. When the processing of step S7 and step S8 has not been executed for all the imaging point icons (NO in step S9), the processing returns to step S6. That is, the display control unit 113 repeats the processing of steps S6 to S9 until the area to which all the imaging point icons belong is specified and the processing of determining whether or not all the imaging point icons are the first imaging point icons is executed. Note that, in a case where the display control unit 113 determines NO in step S9 and the processing returns to step S6, the display control unit 113 newly selects an imaging point icon on which the processing in steps S7 and S8 is not executed from among the plurality of imaging point icons.

Note that, in step S9, the display control unit 113 may determine YES in step S9 in a case where the processing of steps S7 and S8 has been executed for all the imaging point icons included in the area currently displayed on the display in the design drawing 200.

In step S10, the display control unit 113 discriminates the content of the annotation information added to the imaging data of the first imaging point icon for each area.

In step S11, the display control unit 113 grasps the number of first imaging point icons for each area.

In step S12, the display control unit 113 specifies the first area and the second area. The first area is an area including at least one first imaging point icon. The second area is an area not including the first imaging point icon. For example, the area A10 illustrated in FIG. 5 includes one first imaging point icon. In this case, the area A10 corresponds to the first area. On the other hand, for example, it is assumed that the area A14 does not include the first imaging point icon. That is, it is assumed that there is no imaging point icon (first imaging point icon) in which the annotation information is added to the imaging data in the area A14. In this case, the area A14 corresponds to the second area.

In step S13, the display control unit 113 generates an instruction for displaying the first area on the display 23 in a mode different from the second area and transmits the instruction to the information terminal 20. The display control unit 113 generates the above instruction based on at least one of the contents of the comment indicated by the comment information, the type of the label information, and the number of first imaging point icons. The information terminal 20 that has acquired this instruction displays the first area on the display 23 in a mode different from the second area. Hereinafter, details of the processing executed by the display control unit 113 in step S13 will be described with an example.

(First example) The display control unit 113 according to a first example generates an instruction to change the display mode of the first area based on the number of first imaging point icons included in the first area.

Specifically, the display control unit 113 according to the first example changes the display size of the first area according to the number of first imaging point icons included in the first area. That is, the display control unit 113 changes the display size of the first area such that the display size of the first area increases as the first area includes more first imaging point icons. For example, it is assumed that the area A7 illustrated in FIG. 5 includes four first imaging point icons, the area A10 includes one first imaging point icon, and the area A14 does not include any first imaging point icon. In this case, when the display size of the area A7 is X1, the display size of the area A10 is X2, and the display size of the area A14 is X3, the display control unit 113 instructs the information terminal 20 to change the display size of the first area so that a relationship of “X1 > X2 > X3” is established. The display size of the first area refers to the area of one first area on the display screen.

In addition, the display control unit 113 according to the first example may change the color of the first area according to the number of first imaging point icons included in the first area. For example, the display control unit 113 may instruct the information terminal 20 to display the first area including one or two first imaging point icons in green, display the first area including three or four first imaging point icons in yellow, and display the first area including five or more first imaging point icons in red.

As described above, by changing the display mode of the first area according to the number of first imaging point icons, the user can intuitively understand the number of first imaging point icons included in the first area.

(Second example) The display control unit 113 according to a second example generates an instruction for requesting display of the total number of first imaging point icons in the first area.

For example, it is assumed that the area A6 illustrated in FIG. 5 is the first area, and that the area A6 includes a total of four first imaging point icons. In this case, the display control unit 113 instructs the information terminal 20 to display the character “4” in the area A6.

In this manner, by displaying the total number of first imaging point icons on the display screen 401, the user can intuitively understand the total number of first imaging point icons for each first area.

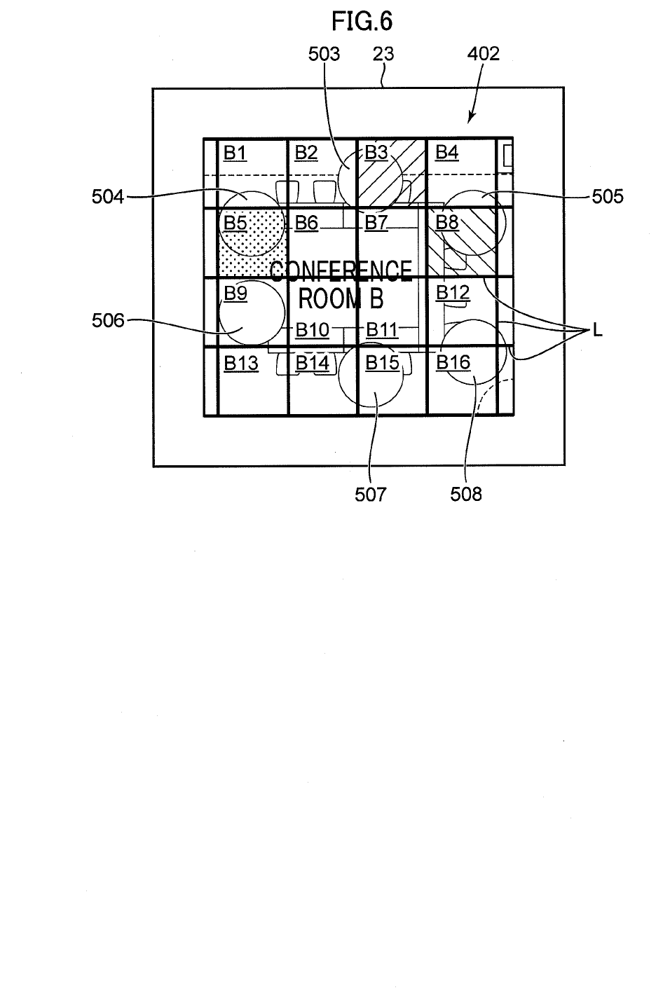

(Third example) FIG. 6 is a view for describing processing of the display control unit 113 according to the third example. FIG. 6 is a view illustrating a display screen 402 displayed on the display 23 when the information terminal 20 receives an operation for designating enlargement of the area VI illustrated in FIG. 4.

On the display screen 402, the design drawing 200 is partitioned into a plurality of areas from an area B1 to an area B16 by the boundary lines L. The area B3 includes an imaging point icon 503, the area B5 includes an imaging point icon 504, the area B8 includes an imaging point icon 505, the area B9 includes an imaging point icon 506, the area B15 includes an imaging point icon 507, and the area B16 includes an imaging point icon 508. The label information of “not started” is added to the imaging data of the imaging point icon 503, the label information of “in progress” is added to the imaging data of the imaging point icon 504, and the label information of “resolved” is added to the imaging data of the imaging point icon 505. That is, the imaging point icon 503, the imaging point icon 504, and the imaging point icon 505 are the first imaging point icons in which the annotation information is added to the imaging data. Therefore, the area B3, the area B5, and the area B8 are the first areas.

The display control unit 113 according to the third example instructs the information terminal 20 to display the first area in different modes for each type of label information associated with the first imaging point icon. For example, the display control unit 113 instructs the information terminal 20 to display, on the display 23, a first area including a first imaging point icon to which the label information of “not started” is added in red, a first area including a first imaging point icon to which the label information of “in progress” is added in yellow, and a first area including a first imaging point icon to which the label information of “resolved” is added in green.

Referring to FIG. 6, as described above, the area B3 includes the imaging point icon 503. Then, the label information of “not started” is added to the imaging data of the imaging point icon 503. In this case, the display control unit 113 displays the area B3 in red. Further, the area B5 includes the imaging point icon 504. Then, the label information of “in progress” is added to the imaging data of the imaging point icon 504. In this case, the display control unit 113 displays the area B5 in yellow. Further, the area B8 includes the imaging point icon 505. Then, the label information of “resolved” is added to the imaging data of the imaging point icon 505. In this case, the display control unit 113 displays the area B8 in green.

As described above, the display control unit 113 according to the third example changes the color of the first area to which the first imaging point icon belongs according to the type of label information added to the imaging data of the first imaging point icon. This allows the user to understand the type of label information added to the first imaging point icon. Moreover, the user can immediately understand the status of each area.

(Fourth example) When one first area includes a plurality of first imaging point icons and label information of different types is added to the plurality of first imaging point icons, the display control unit 113 according to the fourth example instructs the information terminal 20 to display a plurality of colors in the first area.

For example, it is assumed that the label information of “not started” is added to the imaging point icon 505 in the area A7 illustrated in FIG. 5, the label information of “in progress” is added to the imaging point icon 509 and the imaging point icon 510 in the area A7, and the label information of “resolved” is added to the imaging point icon 511 in the area A7.

In this case, the display control unit 113 first partitions the area A7 into three portions of a left portion LE, a center portion CE, and a right portion RI. Then, the display control unit 113 instructs the information terminal 20 to display the left portion LE in a color corresponding to the type of “not started”, for example, red. Further, the display control unit 113 instructs the information terminal 20 to display the center portion CE in a color corresponding to the type of “in progress”, for example, yellow. Further, the display control unit 113 instructs the information terminal 20 to display the right portion RI in a color corresponding to the type of “resolved”, for example, green.

In this manner, it is possible to allow the user to intuitively understand that a plurality of first imaging point icons is included in one first area and that label information of different types is added to imaging data of the plurality of first imaging point icons.

Further, the display control unit 113 according to the fourth example partitions the area A7 into three portions of the left portion LE, the center portion CE, and the right portion RI, and displays the left portion LE in red. As described above, when the left portion LE where the line of sight of a person is likely to gather is displayed in red, which is a noticeable color, the user can be guided to pay attention to the area A7.

The display control unit 113 according to the fourth example may display the total number of first imaging point icons in the first area for each type of label information. For example, in the area A7, there is one first imaging point icon (imaging point icon 505) to which the label information of “not started” is added, there are two first imaging point icons (imaging point icon 509 and imaging point icon 510) to which the label information of “in progress” is added, and there is one first imaging point icon (imaging point icon 511) to which the label information of “resolved” is added. In this case, the display control unit 113 transmits, to the information terminal 20, an instruction to display the character “1” in the left portion LE of the area A7 displayed in red, the character “2” in the center portion CE displayed in yellow, and the character “1” in the right portion RI displayed in green. In this manner, it is possible to allow the user to intuitively understand that, in the area A7, there is one first imaging point icon to which the label information of “not started” is added, there are two first imaging point icons to which the label information of “in progress” is added, and there is one first imaging point icon to which the label information of “resolved” is added.

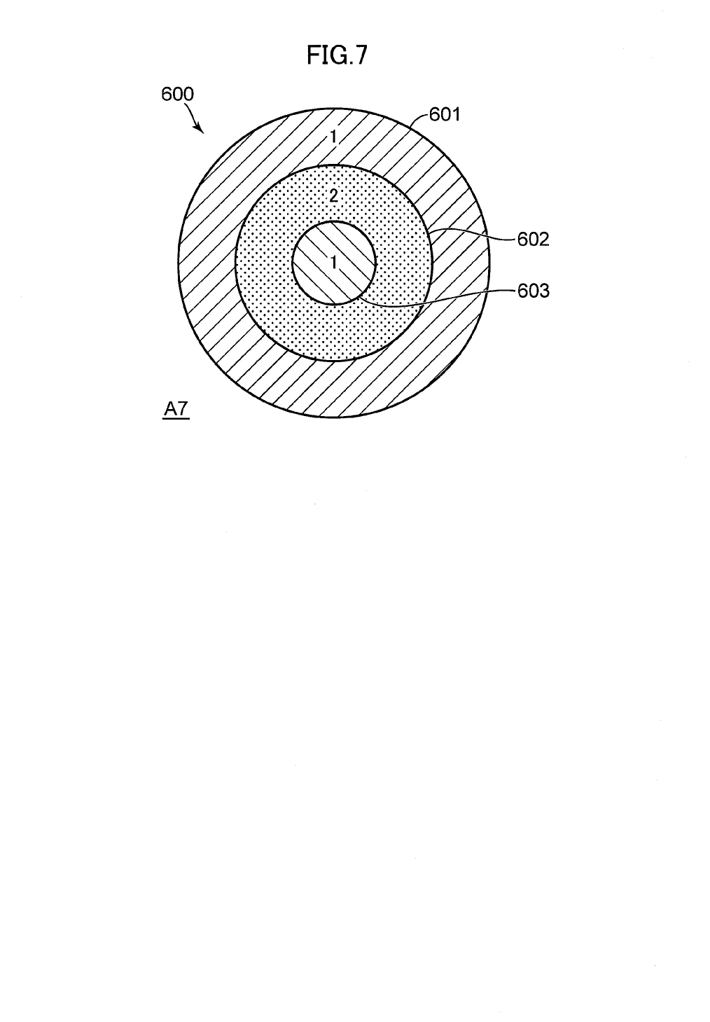

In addition, the display control unit 113 according to the fourth example may instruct the information terminal 20 to display a status icon 600 (FIG. 7) in the area A7. FIG. 7 is a view illustrating an example of the status icon 600. The status icon 600 is constituted by a plurality of circles each having a different radius, each having a different color, and each center point being disposed on the same coordinate on the design drawing. As described above, in the area A7, there is one first imaging point icon to which the label information of “not started” is added, there are two first imaging point icons to which the label information of “in progress” is added, and there is one first imaging point icon to which the label information of “resolved” is added. In this case, the status icon 600 includes a first circle 601, a second circle 602, and a third circle 603. The first circle 601 is a circular image displayed in a color corresponding to the label information of “not started”, for example, red. The second circle 602 is a circular image displayed in a color corresponding to the label information of “in progress”, for example, yellow. The third circle 603 is a circular image displayed in a color corresponding to the label information of “resolved”, for example, green. The radius of the first circle 601 is larger than the radius of the second circle 602, and the radius of the second circle 602 is larger than the radius of the third circle 603. The centers of the first circle 601 to the third circle 603 are disposed at the same position (coordinates). In the first circle 601, the total number of first imaging point icons to which the label information of “not started” is added in the area A7 is displayed. That is, “1” is displayed. In the second circle 602, the total number of first imaging point icons to which the label information of “in progress” is added in the area A7 is displayed. That is, “2” is displayed. In the third circle 603, the total number of first imaging point icons to which the label information of “in progress” is added in the area A7 is displayed. That is, “1” is displayed.

When the status icon 600 is displayed in the area A7, the user can intuitively understand that there is one first imaging point icon to which the label information of “not started” is added, there are two first imaging point icons to which the label information of “in progress” is added, and there is one first imaging point icon to which the label information of “resolved” is added in the area A7.

(Fifth example) The display control unit 113 according to the fifth example detects input of a keyword. Then, the display control unit 113 specifies an area with a keyword including the first imaging point icon in which the comment information including the keyword is added to the imaging data in the first area and makes the display mode of the area with the keyword different from the display mode of the second area.

Specifically, the display control unit 113 according to the fifth example transmits a predetermined instruction to the information terminal 20 and causes the display 23 of the information terminal 20 to display a keyword input field (not illustrated). Then, the user inputs a keyword into the keyword input field through the operation unit 24. The keyword input by the user is acquired by the acquisition unit 111 via the communication unit 13. Upon detecting that the acquisition unit 111 has acquired the keyword, the display control unit 113 specifies an area with a keyword. The area with a keyword refers to the first area including the first imaging point icon in which the comment information including the keyword is added to the imaging data. For example, it is assumed that, in the imaging data of the imaging point icon 512 included in the area A14 illustrated in FIG. 5, comment information indicating a comment such as "Wood is insufficient on May 1. Worker X, Company A" is added. Here, it is assumed that the user inputs the keyword “A company” in the keyword input field. In this case, the display control unit 113 specifies the area A14 as the area with a keyword.

The display control unit 113 that has specified the area with a keyword instructs the information terminal 20 to make the display mode of the area with a keyword different from the display mode of the second area. Specifically, the display control unit 113 makes the display size of the area with a keyword relatively larger than the display size of the second area. For example, when the display size of the area A14, which is the area with a keyword, is Y1 and the display size of the area A14, which is the second area, is Y2, the display control unit 113 changes the display size of the area with a keyword such that “Y1 > Y2” holds. In addition, the display control unit 113 may blink the area with a keyword. For example, it is assumed that not only the comment information but also the label information of “resolved” is added to the imaging data of the imaging point icon 512 in the area A14. In this case, the display control unit 113 blinks the area A14 in green.

As described above, when the area with a keyword is displayed in a display mode different from that of the second area, the user can easily grasp the location of the first imaging point icon to which the comment information including a keyword input by the user is added.

In addition, the display control unit 113 according to the fifth example may change the display mode of the area with a keyword according to the number of first imaging point icons (hereinafter, referred to as an icon with a keyword) to which the comment information including the keyword is added. For example, as the area with a keyword includes more icons with a keyword, the area with a keyword may be displayed larger.

(Sixth example) The display control unit 113 according to the sixth example displays an imaging point icon matching the period input by the user on the design drawing. Then, when the imaging point icon that matches the period input by the user is the first imaging point icon, the display control unit 113 displays the first area including the first imaging point icon in a mode different from the second area.

The display control unit 113 according to the sixth example first causes the display 23 to display a period input field (not illustrated). The period input field is an input field for receiving designation of a period from the user.

Here, it is assumed that the user inputs information designating a period of “April 1, 2024 to April 30, 2024” in the period input field. In this case, the display control unit 113 causes the display 23 to display the imaging point icon associated with the imaging data captured between April 1, 2024 and April 30, 2024.

The area A11 illustrated in FIG. 5 will be described as an example. Upon detecting that the user inputs the information designating the period, the display control unit 113 confirms the imaging date and time added to the imaging data of the imaging point icon included in the area A11. For example, it is assumed that information indicating that the image is captured on April 1, 2024, is added to the imaging data of the imaging point icon 513 included in the area A11. Further, it is assumed that information indicating that the image is captured on May 1, 2024, is added to the imaging data of the imaging point icon 514 in the area A11. It is assumed that information indicating that the image is captured on June 1, 2024, is added to the imaging data of the imaging point icon 515 in the area A11. In this case, the display control unit 113 displays only the imaging point icon 513 in the area A11. On the other hand, the imaging point icons 514 and 515 are not displayed in the area A11.

Here, when the imaging point icon 513 is the first imaging point icon, the display control unit 113 handles the area A11 as the first area. Then, the display control unit 113 makes the display mode of the area A11 (first area) different from that of the second area. For example, in a case where the label information of “not started” is added to the imaging data of the imaging point icon 513, the display control unit 113 displays the area A11 in red.

Further, it is assumed that the user inputs information designating a period of “May 1, 2024 to May 31, 2024” in the period input field. In this case, the display control unit 113 displays the imaging point icon 514 associated with the imaging data captured on May 1 in the area A11. Here, it is assumed that the label information of “in progress” is added to the imaging data of the imaging point icon 514. In this case, the display control unit 113 displays the area A11 in yellow, for example.

Further, it is assumed that the user inputs information designating a period of “June 1, 2024 to June 30, 2024” in the period input field. In this case, the display control unit 113 displays the imaging point icon 515 associated with the imaging data captured on June 1 in the area A11. Here, it is assumed that the label information of “resolved” is added to the imaging data of the imaging point icon 515. In this case, the display control unit 113 displays the area A11 in green, for example.

In this manner, the user can intuitively understand the progress status of work at the construction site. In the above example, in the area A11, the user can intuitively understand that the worker has started work in April 2024, the work is in progress as of May 2024, and the work has been completed in June 2024.

Note that, it is assumed that, when the user inputs information designating a period of “July 1, 2024 to July 31, 2024” in the period input field, the display control unit 113 does not display the imaging point icon in the area A11. In this case, the display control unit 113 handles the area A11 as the second area.

Further, a plurality of pieces of imaging data captured at different imaging dates and times may be associated with one imaging point icon. For example, first imaging data, second imaging data, and third imaging data are associated with the imaging point icon 516 illustrated in the area A8. The first imaging data is data captured at the imaging point indicated by the imaging point icon 516 on April 1. The second imaging data is data captured at the imaging point indicated by the imaging point icon 516 on May 1. The third imaging data is data captured on June 1 at the imaging point indicated by the imaging point icon 516. The label information indicating a status of “not started” is added to the first imaging data, the label information indicating a status of “in progress” is added to the second imaging data, and the label information indicating a status of “resolved” is added to the third imaging data.

Here, it is assumed that the user inputs information designating a period of “April 1, 2024, to April 30, 2024” in the period input field. In this case, the display control unit 113 displays the area A8, which is an area including the imaging point icon 516, in green based on the first imaging data among the imaging data associated with the imaging point icon 516. Note that, it is assumed that, when the user inputs information designating a period of “May 1, 2024, to May 31, 2024” in the period input field, the display control unit 113 displays the area A8 in yellow. Further, when the user inputs information designating a period of “June 1, 2024, to June 30, 2024”, the display control unit 113 displays the area A8 in red.

(Seventh example) The display control unit 113 according to the seventh example instructs the information terminal 20 to make the display mode of the first imaging point icon different from the display mode of the second imaging point icon. For example, the display control unit 113 instructs the information terminal 20 to make the color of the first imaging point icon different from the color of the second imaging point icon. Alternatively, the display control unit 113 instructs the information terminal 20 to configure the first imaging point icon with a quadrangular image and configure the second imaging point icon with a circular image. In addition, the display control unit 113 may make the first imaging point icon different from the second imaging point icon by an appropriate method.

The display methods according to the first to seventh examples are merely examples. The display control unit 113 may cause the display 23 to display the first area in a mode different from the second area by a method different from the display methods according to the first to seventh examples. In addition, the display methods according to the first to seventh examples may be appropriately combined.

According to the information processing system 1 described above, the first area including the first imaging point icon can be displayed on the display 23 in a mode different from the second area not including the first imaging point icon. That is, it is possible to make the first area including the first imaging point icon that is the imaging point icon in which the annotation information is added to the imaging data stand out. Thus, it is possible to clarify the location of the imaging point icon in which the annotation information is added to the imaging data. As a result, it is not necessary to input an operation for searching for the imaging point icon in which the annotation information is added to the imaging data to the server 10 or the like, and thus it is possible to suppress an increase in the processing steps of the server 10 or the like. Therefore, it is possible to suppress an increase in load on the server 10 and the like.

A modification below can be employed for the present disclosure.
(1) The processing according to steps S2 and S3 in FIG. 3 is not essential. Further, the processing according to steps S4 and S5 in FIG. 3 is not essential.
(2) In order to make the display of the first area different from the display of the second area, the display control unit 113 may execute the processing according to steps S4 and S5 in FIG. 3.
(3) The design drawing may include floor plan information indicating a shape of each of a plurality of spaces included in the building. Then, in a case where the enlargement or reduction of the design drawing is detected, the display control unit 113 may set the boundary lines L of the shape along each shape of the plurality of spaces in the design drawing based on the floor plan information.

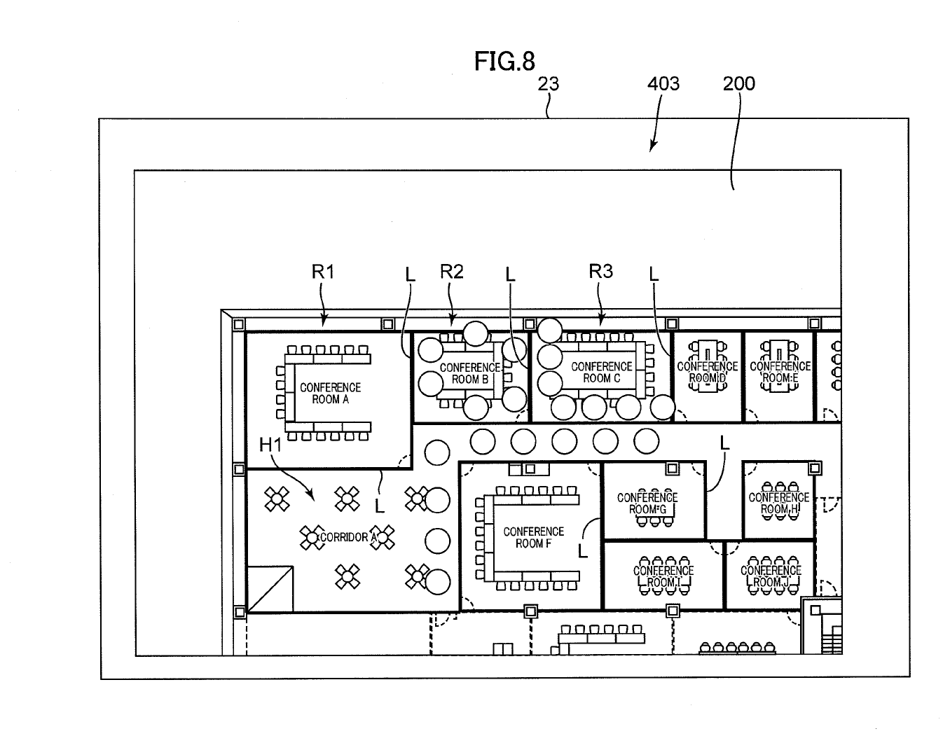

In the design drawing, a line (an example of floor plan information) indicating a wall of the building may be drawn. For example, a line indicating a partition wall for partitioning a room from another room, a line indicating a partition wall for partitioning a room from a corridor, and the like may be written in the design drawing. When a line indicating a wall is drawn in the design drawing and the enlargement ratio of the design drawing is set to a predetermined enlargement ratio (for example, an enlargement ratio of 50%), the display control unit 113 may set the boundary lines L along the line indicating the wall. FIG. 8 is a view illustrating an example of a display screen 403 displayed on the display 23 in the present modification. In the example illustrated in FIG. 8, the boundary lines L are set along a partition wall disposed between the room R1 and the room R2, a partition wall disposed between the room R1 and the corridor H1, and the like.

According to the present modification, the display control unit 113 can vary the display mode for each space such as a room or a corridor included in the building. For example, if the label information of “not started” is added to imaging data of a predetermined imaging point icon in the room R2, the display control unit 113 displays the room R2 in red. Further, if the label information of “resolved” is added to the imaging data of the predetermined imaging point icon in the room R3, the display control unit 113 displays the room R3 in green. Further, the display control unit 113 does not particularly change the display mode for the second area such as the room R1. In this manner, the user can easily grasp the status of each space included in the building, for example, the progress status of predetermined work in each space for each space.

In addition, the display control unit 113 according to the present modification may set in each area an additional boundary line for further finely dividing each area. At this time, the display control unit 113 may set another boundary line so that each area is partitioned into a plurality of areas having a similar shape to each area.

(4) The display control unit 113 may partition the design drawing for each function. For example, the design drawing may be divided into a plurality of areas such as a conference room area, a habitable area, and an elevator area.

Specifically, the design drawing according to the present modification is associated with function information indicating the function of each of the plurality of spaces of the building. For example, information indicating that a space described in the design drawing has a function of a “conference room”, that another space described in the design drawing has a function of a “corridor (passage)”, that still another space described in the design drawing has a function of a “habitable room”, that still another space described in the design drawing has a function of an “elevator”, and the like is associated with the design drawing.

The display control unit 113 according to the present modification sets the boundary lines L in the design drawing so that the design drawing is partitioned for each function of the plurality of spaces when detecting enlargement or reduction of the design drawing. For example, in a case where the enlargement ratio of the design drawing is set to a predetermined enlargement ratio, the display control unit 113 sets the boundary lines L such that spaces having the function of the conference room are collectively displayed as the conference room area, the spaces having the function of the corridor are collectively displayed as the corridor area, spaces having the function of the habitable room are collectively displayed as the habitable area, and spaces having the function of the elevator are collectively displayed as the elevator area.

In this manner, since the design drawing is divided into areas based on the function of each space included in the building, the user can easily grasp the progress status of work in each area and the like for each area.

(5) When the enlargement ratio of the design drawing is set to a predetermined enlargement ratio (for example, an enlargement ratio of 30%), the display control unit 113 may draw the boundary lines L such that the design drawing is partitioned into four areas (sectors) such as an east area, a west area, a south area, and a north area.

(6) In the first embodiment, an example in which the design drawing 200 is stored in the design drawing information storage 121 has been described, but the design drawing stored in the design drawing information storage 121 is not limited to the design drawing 200. The design drawing information storage 121 may store a design drawing including a first-floor map corresponding to the first floor included in the building and a second-floor map corresponding to the second floor included in the building. The first-floor map is, for example, a floor plan illustrating a floor plan of the first floor of a building. The second-floor map is, for example, a floor plan illustrating a floor plan of the second floor of the building. That is, the design drawing may be image data in which the floor map of the first floor and the floor map of the second floor of the building are displayed in a list form. The display control unit 113 may display a plurality of imaging point icons on each of the first-floor map and the second-floor map. Then, among the first floor map and the second floor map, the floor map including the first imaging point icon may be treated as the first area, the floor map not including the first imaging point icon may be treated as the second area, and the display of the first area may be made different from that of the second area.

(7) The design drawing may display a map (an example of a bird’s-eye view) on the display 23. The map is an area map indicating a position of a building, a facility, or the like. The display control unit 113 may divide the map into a plurality of areas by displaying grid lines on the map. The display control unit 113 may display a plurality of imaging point icons on the map. The display control unit 113 may display the first area including the first imaging point icon among the plurality of areas on the map in a mode different from the second area not including the first imaging point icon.

(8) When the enlargement ratio designated by the user is equal to or larger than the reference enlargement ratio, the display control unit 113 may display the guidance information on the display 23.

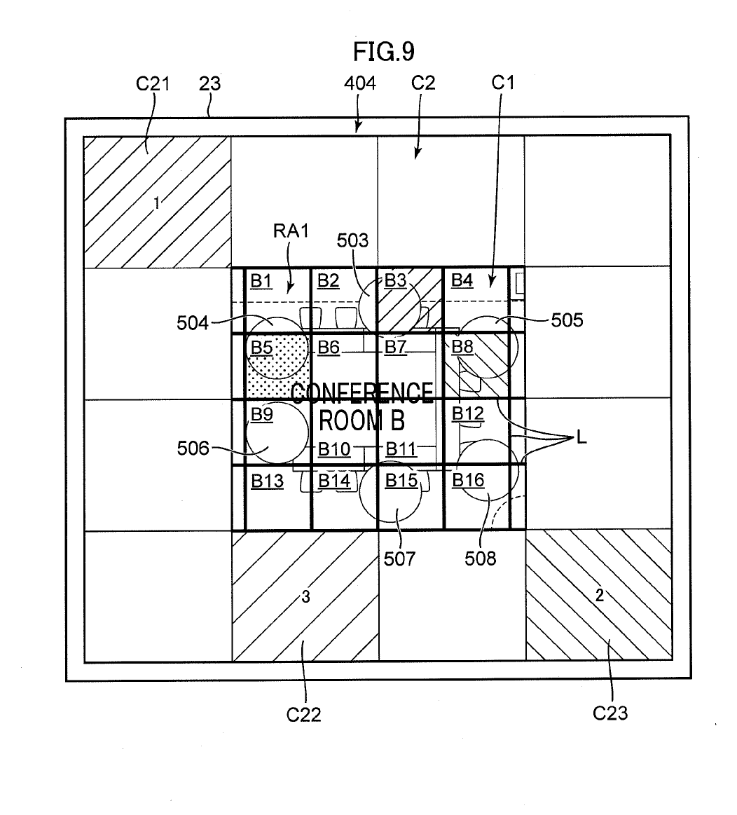

The display control unit 113 according to the present modification first detects that the user has input an operation of enlarging the design drawing. Subsequently, the display control unit 113 displays the design drawing set to the enlargement ratio designated by the user on the display 23. Hereinafter, a range that is a part of the entire design drawing and is displayed on the display 23 based on the enlargement operation of the user is referred to as a first range RA1 (FIG. 9). Further, in the entire design drawing, a range other than the first range RA1 is referred to as a second range. That is, in the entire design drawing, a portion displayed on the display 23 is referred to as a first range RA1, and a portion not displayed on the display 23 (a portion present outside the display screen) is referred to as a second range.

Subsequently, the display control unit 113 determines whether or not the enlargement ratio of the design drawing designated by the user is equal to or larger than the reference enlargement ratio. When the enlargement ratio designated by the user is equal to or larger than the reference enlargement ratio, the display control unit 113 specifies the position of the first range RA1. Specifically, the position information on the design drawing 200 of the first range RA1 is acquired. The position information on the design drawing 200 of the first range RA1 includes coordinate values on the design drawing 200 of key points (for example, four corners) of the first range RA1. Subsequently, the display control unit 113 specifies the positions and the number of first imaging point icons included in the second range. Specifically, the position information (coordinate values) on the design drawing 200 of each of the first imaging point icons present in the second range and the number thereof are acquired. At this time, the display control unit 113 acquires a relative positional relationship between the position on the design drawing of the first imaging point icon present in the second range and the position on the design drawing 200 of the first range RA1 for each of the first imaging point icons present in the second range. Subsequently, the display control unit 113 displays, on the display 23, guidance information indicating the position and the number on the design drawing of each of the first imaging point icons included in the second range.

FIG. 9 is a view illustrating an example of a display screen 404 displayed on the display 23 in the present modification. As illustrated in FIG. 9, the display screen 404 includes a first range display field C1 and a guidance information display field C2. The first range display field C1 displays the first range RA1. The guidance information display field C2 displays guidance information. The guidance information display field C2 according to the present modification includes 12 cells disposed around the first range display field C1.

It is assumed that the display control unit 113 specifies that there is one first imaging point icon in a portion located in the upper left direction with respect to the first range RA1 in the second range. In this case, the display control unit 113 writes a number “1” in the cell C21 disposed in the upper left direction of the first range display field C1 on the display screen 404.

Further, it is assumed that the display control unit 113 specifies that there are three first imaging point icons in a portion located in the lower left direction with respect to the first range RA1 in the second range. In this case, the display control unit 113 writes a number “3” in the cell C22 disposed in the lower left direction of the first range display field C1 on the display screen 404.

Further, it is assumed that two first imaging point icons are present in a portion located in the lower right direction with respect to the first range RA1 in the second range. In this case, the display control unit 113 writes a number “2” in the cell C23 disposed in the lower right direction of the first range display field C1 on the display screen 404.

In addition, the display control unit 113 may change the color, the display size, and the like of the cells included in the guidance information display field C2 based on the content (type of label information, content of comment included in comment information, and the like) of the annotation information added to the imaging data of the first imaging point icon and the total number of first imaging point icons.

According to the configuration of the present modification, when the first range RA1 of the design drawing 200 is displayed on the display screen 404, it is possible to present the user with guidance information indicating the positions and the number of first imaging point icons present outside the display screen (second range). In this manner, the user can easily grasp the position and the number of the first icons present outside the display screen.

Note that when the enlargement ratio of the design drawing designated by the user is less than the reference enlargement ratio, the display control unit 113 does not display the guidance information on the display 23.

The technology according to the present disclosure is useful in the technical field of displaying an image on a display.

1. An information processing method in a computer, comprising:
displaying, on a display, a bird’s-eye view on which a plurality of imaging point icons are overlaid;
partitioning the bird’s-eye view into a plurality of areas,
each of the plurality of imaging point icons being associated with imaging data captured at imaging points corresponding to the plurality of imaging point icons,
annotation information being added to the imaging data associated with at least one first imaging point icon included in the plurality of imaging point icons; and
displaying, on the display, a first area including the at least one first imaging point icon in a display mode different from a display mode of a second area that does not include the at least one first imaging point icon.

2. The information processing method according to claim 1, further comprising detecting enlargement or reduction of the bird’s-eye view,
wherein the displaying the first area on the display in a mode different from the second area is performed in response to detection of enlargement or reduction of the bird’s-eye view.

3. The information processing method according to claim 1, wherein the displaying the first area on the display in a mode different from the second area includes changing a display mode of the first area based on a number of the first imaging point icons included in the first area.

4. The information processing method according to claim 1, wherein the displaying the first area on the display in a mode different from the second area includes displaying a total number of the first imaging point icons in the first area.

5. The information processing method according to claim 1, wherein
the annotation information includes label information indicating a status of a subject related to the imaging data, and
the displaying the first area on the display in a mode different from the second area includes displaying the first area in a different mode for each type of the label information added to the imaging data of the first imaging point icon.

6. The information processing method according to claim 1, wherein
the annotation information includes comment information indicating a comment added to the imaging data,
the information processing method further comprising detecting an input of a keyword,
wherein the displaying the first area on the display in a mode different from the second area includes:
specifying, in the first area, an area with a keyword including the first imaging point icon in which comment information including the keyword is added to the imaging data; and
making a display mode of the area with a keyword different from a display mode of the second area.

7. The information processing method according to claim 1, wherein the displaying the first area on the display in a mode different from the second area includes making a display mode of the first imaging point icon different from a display mode of at least one second imaging point icon included in the plurality of imaging point icons, the second imaging point icon having no annotation information added to the imaging data.

8. The information processing method according to claim 7, further comprising:
detecting enlargement or reduction of the bird’s-eye view; and
determining whether or not a degree of overlap between the first imaging point icon and the second imaging point icon is equal to or greater than a reference degree of overlap in response to detection of enlargement or reduction of the bird’s-eye view,
wherein the displaying the first area on the display in a mode different from the second area includes making a display mode of the first imaging point icon different from a display mode of the second imaging point icon when the degree of overlap between the first imaging point icon and the second imaging point icon is equal to or greater than the reference degree of overlap.

9. The information processing method according to claim 1, wherein the partitioning the bird’s-eye view into the plurality of areas includes setting a grid-like boundary line in the bird’s-eye view.

10. The information processing method according to claim 1, wherein
the bird’s-eye view includes floor plan information indicating a shape of each of a plurality of spaces included in a building,
the information processing method further comprising detecting enlargement or reduction of the bird’s-eye view,
wherein the partitioning the bird’s-eye view into the plurality of areas includes setting a boundary line of a shape along the shape of each of the plurality of spaces in the bird’s-eye view based on the floor plan information in response to detection of enlargement or reduction of the bird’s-eye view.

1111 The information processing method according to claim 1, wherein
the bird’s-eye view is associated with function information indicating a function of each of a plurality of spaces of a building,
the information processing method further comprising detecting enlargement or reduction of the bird’s-eye view,
wherein the partitioning the bird’s-eye view into the plurality of areas includes setting a boundary line in the bird’s-eye view such that the bird’s-eye view is partitioned for each function of the plurality of spaces in response to detection of enlargement or reduction of the bird’s-eye view.

12. The information processing method according to claim 1, wherein
the bird’s-eye view includes a first floor map corresponding to a first floor included in a building and a second floor map corresponding to a second floor different from the first floor included in the building, and
the displaying the first area on the display in a mode different from the second area includes displaying a floor map including the first imaging point icon out of the first floor map and the second floor map on the display in a mode different from a floor map not including the first imaging point icon.

13. The information processing method according to claim 1, further comprising:
detecting enlargement of the bird’s-eye view;
determining whether or not an enlargement ratio is equal to or larger than a reference enlargement ratio when the enlargement of the bird’s-eye view is detected;
specifying a position of a first range displayed on the display in the bird’s-eye view and positions and a number of the first imaging point icons included in a second range not displayed on the display in the bird’s-eye view when the enlargement ratio is equal to or larger than the reference enlargement ratio; and
displaying guidance information indicating positions and the number of the first imaging point icons included in the second range on the display together with the first range.

14. An information processing device comprising a processor,
wherein the processor is configured to execute:
displaying, on a display, a bird’s-eye view on which a plurality of imaging point icons are overlaid;
partitioning the bird’s-eye view into a plurality of areas,
each of the plurality of imaging point icons being associated with imaging data captured at imaging points corresponding to the plurality of imaging point icons,
annotation information being added to the imaging data associated with at least one first imaging point icon included in the plurality of imaging point icons; and
displaying, on the display, a first area including the at least one first imaging point icon in a display mode different from a display mode of a second area that does not include the at least one first imaging point icon.

15. A non-transitory computer readable recording medium storing an information processing program causing a computer to execute:
displaying, on a display, a bird’s-eye view on which a plurality of imaging point icons are overlaid;
partitioning the bird’s-eye view into a plurality of areas,
each of the plurality of imaging point icons being associated with imaging data captured at imaging points corresponding to the plurality of imaging point icons,
annotation information being added to the imaging data associated with at least one first imaging point icon included in the plurality of imaging point icons; and
displaying, on the display, a first area including the at least one first imaging point icon in a display mode different from a display mode of a second area that does not include the at least one first imaging point icon.
